(19) United States
(12) Patent Application Publication
(10) Pub. No.: US 2009/0191843 A1
(43) Pub. Date: Jul. 30, 2009

(54) METHOD OF RECRUITING A NEW SUBSCRIBER TO A COMMUNICATION SERVICES PROVIDER

(75) Inventor: Eitan MARDIKS, Ra'anana (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd., Kfar Saba (IL)

(21) Appl. No.: 12/128,641

(22) Filed: May 29, 2008

Related U.S. Application Data
(63) Continuation-in-part of application No. 12/020,551, filed on Jan. 27, 2008.

(51) Int. Cl. H04M 11/00

(52) U.S. Cl. 455/405

(57) ABSTRACT

To recruit a new subscriber to a communication services provider, when a request is received, from a host of an identity module that lacks any portion of a provider profile that associates the identity module with a communication services provider, to provide a customization suite for installing substantially all of the provider profile in the identity module, terms of usage are proposed to the host. If the host consents to the terms of usage, the customization suite is sent to the host.

This is a continuation-in-part of U.S. patent application Ser. No. 12/020,551, filed Jan. 27, 2008

This application is related to U.S. patent application Ser. No. 12/______ of the same inventors, which is entitled “GENERIC IDENTITY MODULE FOR TELECOMMUNICATION SERVICES” and filed on the same day as the present application. The latter application, also claiming priority from U.S. patent application Ser. No. 12,020,551, is incorporated in its entirety as if fully set forth herein.

### FIELD OF THE INVENTION

Various embodiments are related to a generic identity module that can be personalized after delivery to a user of a mobile telecommunications device in the course of subscribing to a provider of telecommunications services.

### BACKGROUND

A mobile telecommunications device such as a cellular telephone generally has installed within it an identity module that identifies the user to the provider of telecommunications services to which the user of the device has subscribed. Different telecommunications standards have different names for such an identity module, including: Subscriber Identity Module (SIM) in the GSM standard, Universal Integrated Circuit Card (UICC) in the UMTS standard, and Removable User Identity Module (RUIM) in the CDMA standard. The identity module has stored securely therein one or more digital strings that identify the device in which the identity module is installed with a subscriber of the telecommunications services' provider. In the case of a SIM card, these strings include a unique International Mobile Subscriber Identity (IMSI) and one or more 128-bit authentication keys (Ki).

Identity modules generally, and in particular the “generic” identity module disclosed herein, are discussed herein in terms of SIMs according to the GSM standard. However, it will be clear to those skilled in the art how to apply the principles disclosed herein to identity modules of other telecommunication standards.

FIG. 1 is a high level block diagram of a conventional SIM 10. SIM 10 includes a processor 12, an external interface 14, and three memories: RAM 16, ROM 18 and EEPROM 20, all communicating with each other via a bus 22. RAM 16 is used by processor 12 as a working memory, for execution of code 30 stored in ROM 18 and EEPROM 20. Data 24, such as a SIM file system 38, as well as an IMSI and one or more Ki's, that personalize SIM 10 and associate SIM 10 with a provider of telecommunication services, are stored in EEPROM 20.

FIG. 1 is a block diagram of a legacy SIM 10. High-capacity SIMs 10 have two interfaces 14, one for SIM functionality and the other for storage access.

FIG. 2 shows the hierarchical architecture of code 30 and its relationship to data 24. The lower layer of code 30 is an operating system 34 that includes a driver 32 of interface 14. (Operating system 34 of a high capacity SIM 10 would have two such drivers 32 for its two interfaces 14.) Optionally, operating system 34 also includes a JAVA virtual machine 40. Operating system 34 includes, inter alia, communications code that is executed by processor 12 in support of communication between the mobile telecommunications device, wherein SIM 10 is installed, and the telecommunications network of the provider that SIM 10 associates with the mobile telecommunications device. Above operating system 34 are SIM file system 38 and provider-specific JAVA applets 46. SIM file system 38 includes standard files 42 that are defined by the GSM standard and provider-defined files 44 that are specific to the provider. Some of standard files 42 and provider-defined files 44 are an electrical profile of SIM 10. FIG. 1 shows that code 30 is distributed between code portion 30A in ROM 18 and code portion 30B in EEPROM 20. JAVA applets 46 are considered herein to be a part of code 30 and are stored in EEPROM 20. The remaining part of code 30 is stored in ROM 18. File system 38 is stored in EEPROM 20.

A SIM manufacturer contracting with a telecommunications service provider to provide devices such as SIM 10, installs all of code 30 and data 24 in SIM 10. Each such SIM 10 has unique data 24 (e.g. a unique IMSI and one or more unique Ki's) that, after the telecommunications services provider provides the SIM 10 to a subscriber, identifies the telecommunications device in which that SIM 10 is installed as belonging to that subscriber.

Initially, before being associated with a specific telecommunications services provider, each SIM 10 is generic. It would be highly advantageous to be able to sell is such generic SIMs directly to users, and have the SIMs be personalized for the users as part of the procedure by which the users subscribe to their selected telecommunications services providers. Such generic SIMs could be sold by vendors who are not associated with specific telecommunications providers.

### SUMMARY OF THE INVENTION

Herein is presented a method of recruiting a new subscriber to a communication services provider, including: (a) receiving a request to provide a customization suite for installing substantially all of a provider profile in an identity module in order to associate the identity module with a communication services provider, thereby enabling the identity module to support communication services provided by the communication services provider, the request being received from a host of the identity module, the identity module lacking any portion of the provider profile; (b) responding to the request by proposing to the host terms of usage of the communication services; and (c) upon receiving from the host a consent to the terms of usage, sending the customization suite to the host.

Herein is presented a method of doing business, including: (a) obtaining an identity module for using a host, wherein the identity module is operationally connected, to communicate using communication services provided by a communication services provider when the identity module has installed therein a provider profile that associates the identity module with the communication services provider, the identity module initially lacking any portion of any such provider profile; and (b) offering the identity module for sale to a potential subscriber of such a communication services provider.

Herein is presented a method of doing business, including: (a) configuring an identity module initially without any portion of a provider profile that associates the identity module with a communication services provider, the identity module being for using a host, wherein the identity module is operationally connected, to communicate using communication services provided by the communication services provider with which the identity module is associated by the provider profile; and (b) offering the identity module so configured for sale to a potential subscriber of such a communication services provider.

In a method of recruiting a new subscriber to a communication services provider, a request is received to provide a customization suite for installing substantially all of a provider profile in an identity module in order to associate the identity module with the communication services provider. With the provider profile installed therein, the identity module supports communication services provided by the communication services provider. The request is received from a host of the identity module, such as a cellular telephone or a computer equipped with a card reader. When the request is received, no portion of the provider profile is installed in the identity module. Then, the request is responded to by proposing to the host terms of usage of the communication services. Upon receiving consent to the terms of usage from the host, the customization suite is sent to the host.

Preferably, the method also includes establishing a secure channel to the host. The customization suite is sent to the host via the secure channel.

Preferably, the consent includes a credential such as a credit card number. The method includes validating the credential. The sending of the customization suite to the host is conditional on the credential being valid.

Preferably, the receiving of the request, the responding to the request and the sending of the customization suite are via a telecommunication network such as a is telephony network or an internetwork.

A method of doing business includes obtaining an identity module that initially lacks any portion of any provider profile that associates the identity module with any communication services provider, and offering the identity module for sale to a potential subscriber of one such communication services provider. This is as opposed to offering such an identity module for sale to a communication services provider for personalization by the communication services provider. Preferably, the method also includes requesting a provider profile on behalf of the potential subscriber.

Another method of doing business includes configuring such an identity module initially without any portion of a provider profile and offering the identity module so configured for sale, directly or indirectly, to a potential subscriber of a communication services provider. This is as opposed to offering the identity module for sale to the communication services provider itself.

### BRIEF DESCRIPTION OF THE DRAWINGS

The generic identity module is herein described, by way of example only, with reference to the accompanying drawings, wherein:

FIG. 1 is a high-level block diagram of a conventional SIM;

FIG. 2 shows the hierarchical architecture of the code of a conventional SIM;

FIG. 3 is a high-level block diagram of an embodiment of a generic, pre-customization SIM;

FIGS. 4A and 4C show the hierarchical architectures of the codes and data of two different generic SIMs prior to the installation of provider profiles;

FIG. 4B shows the hierarchical architecture of the code and data of the generic SIM of FIG. 4A after the installation of a provider profile;

FIG. 5 shows the exchange of signals between a generic SIM and a server for requesting a provider profile;

FIG. 6 is a high-level block diagram of a generic SIM in a cellular telephone requesting a provider profile from a server;

FIG. 7 shows the hierarchical architecture of the code and data of a generic SIM after the installation of two provider profiles;

FIG. 8 is a high-level block diagram of a generic SIM coupled by a card reader to a computer requesting a provider profile from a server.

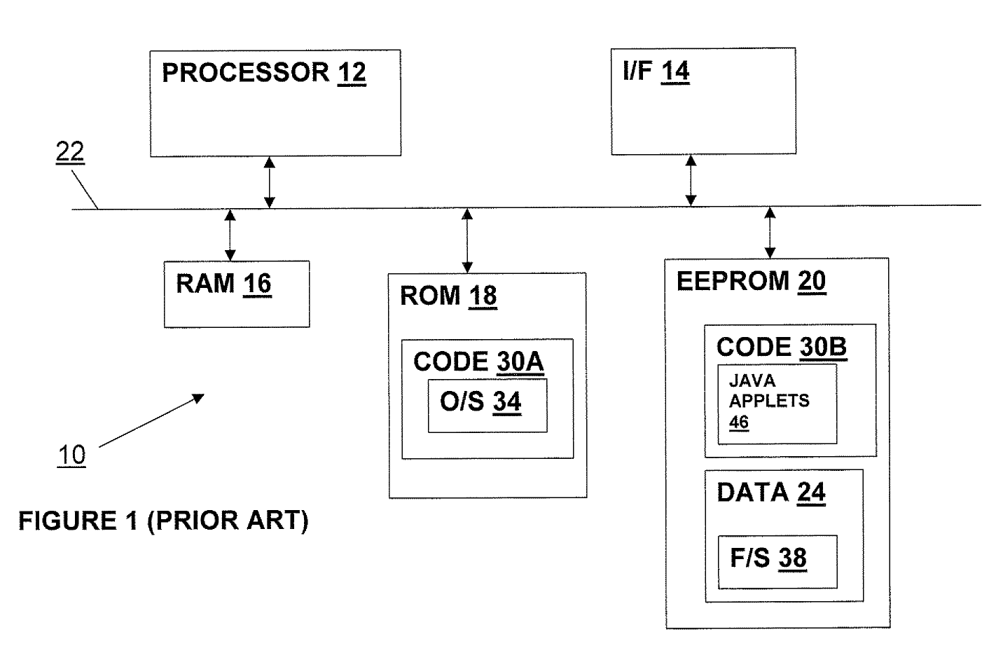

### DESCRIPTION OF THE PREFERRED EMBODIMENTS

The principles and operation of a generic identity module may be better understood with reference to the drawings and the accompanying description.

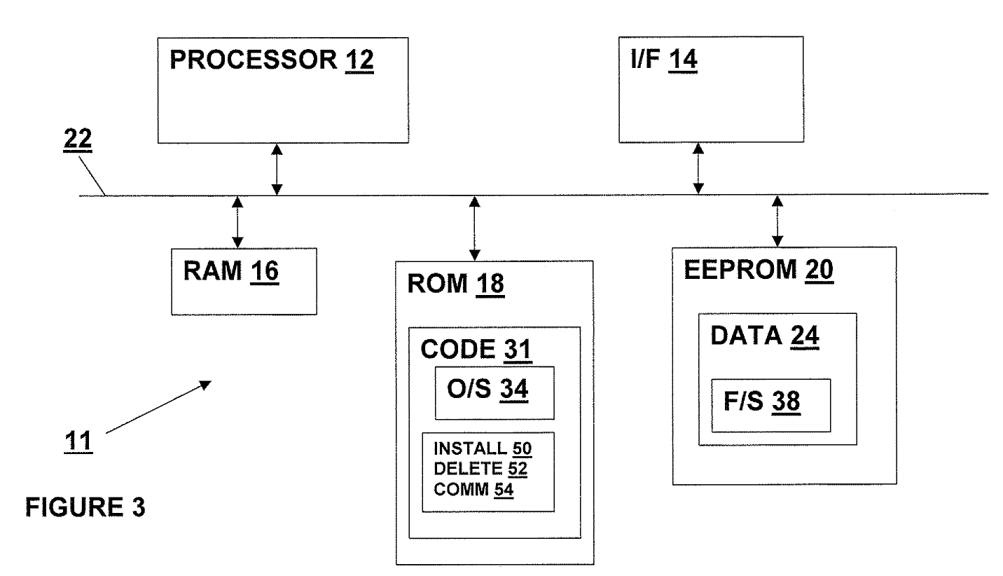

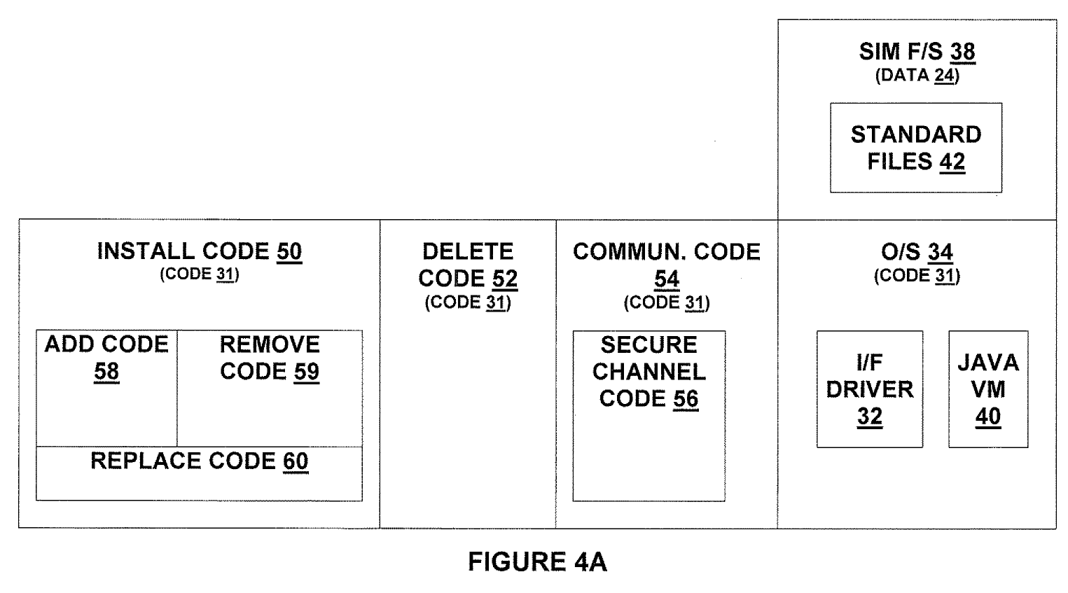

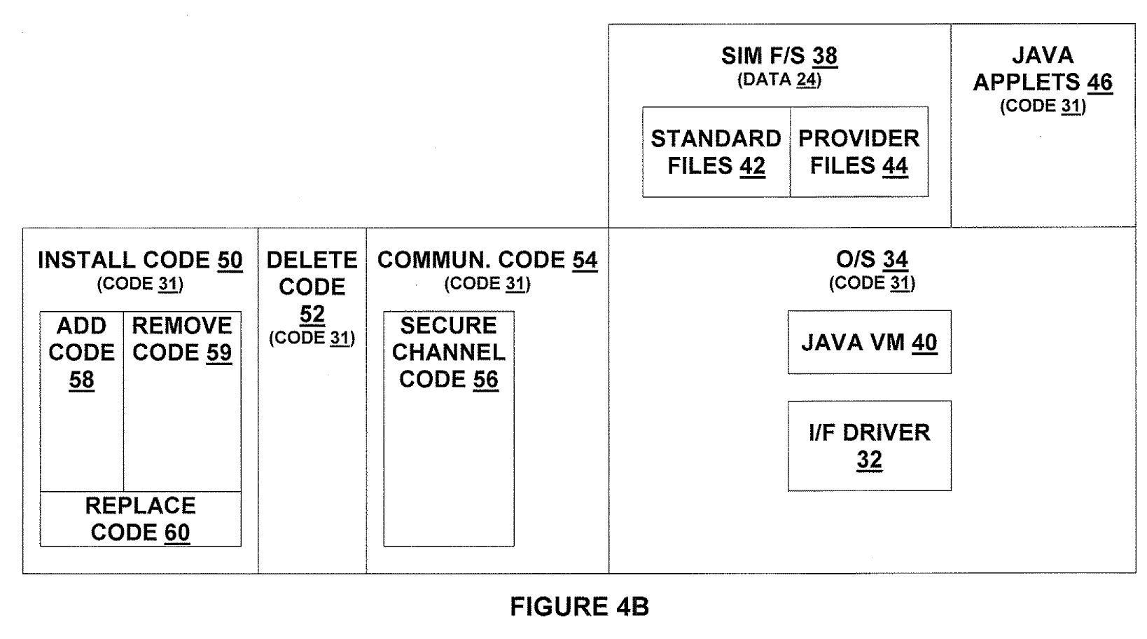

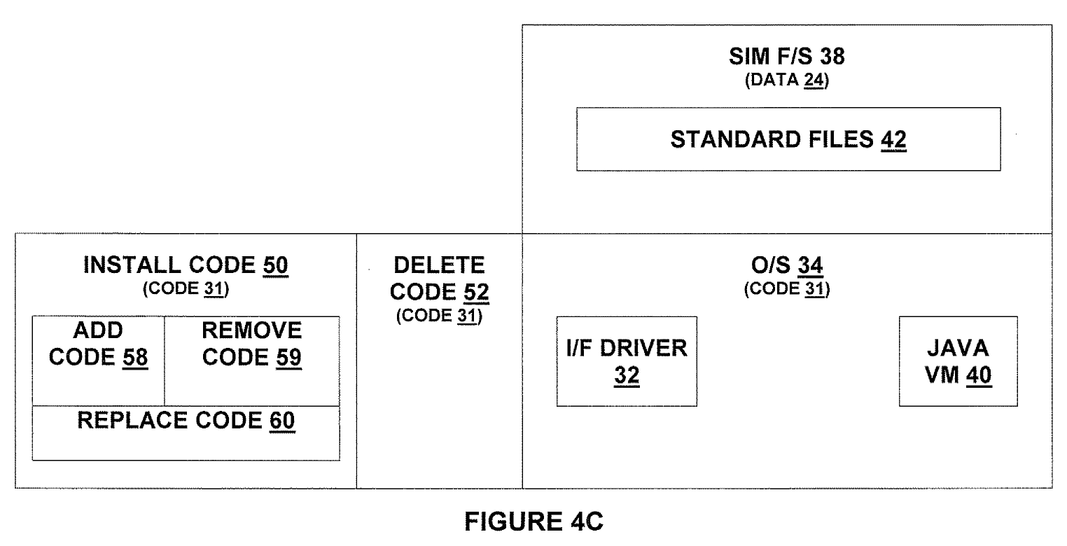

Referring again to the drawings, FIG. 3 illustrates a generic SIM 11 that can be personalized at will for a user. SIM 11 is identical to SIM 10, except that code 30 is replaced with modified code 31. FIG. 4A shows the hierarchical architecture of code 31 of an exemplary embodiment of such a generic SIM and its relation to data 24.

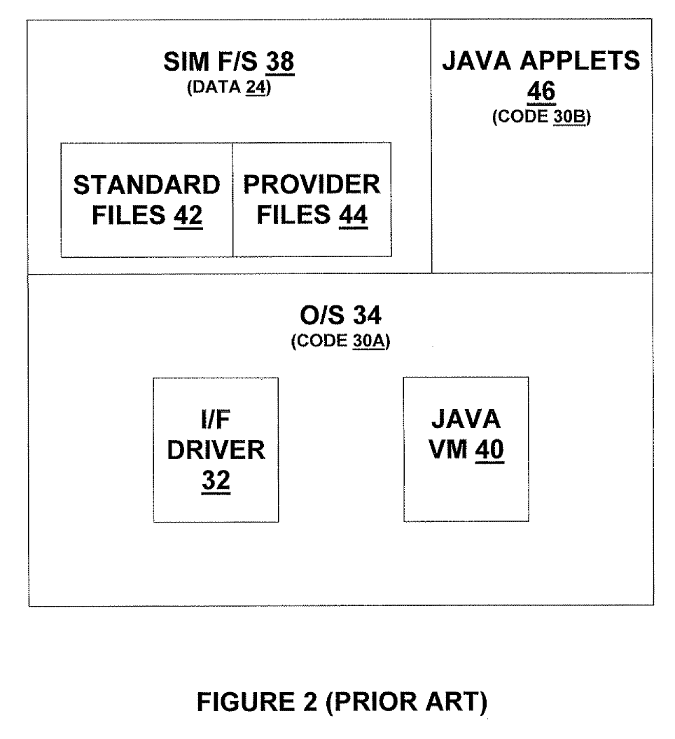

Like code 30 and data 24 of FIG. 2, code 31 and data 24 of FIG. 4A includes an operating system 34 with a driver 32 of interface 14 and a JAVA virtual machine 40, and a SIM file system 38 with standard files 42 but does not include either provider-defined SIM files 44 or any JAVA applets 46. Instead, code 31 of FIG. 4A includes installation code 50 for installing, in EEPROM 20 of SIM 11, the portion of code 30 and data 24 of FIG. 2 (provider-defined files 44 and JAVA applets 46) that associates conventional SIM 10 with a specific telecommunications services provider, and also for installing, in EEPROM 20 of SIM 11, data 24 that personalize SIM 11 for a specific subscriber of the telecommunications services provider. Installation code 50 is functionally equivalent to the code that a manufacturer of SIM 10 uses to install provider-defined files 44, JAVA applets 40 and the rest of data 24 in SIM 10.

After processor 12 has executed installation code 50, the hierarchical architecture of code 31 and its relation to data 24 is as illustrated in FIG. 4B. Hence, provider-defined portion 44, JAVA applets 46 and the related data 24 are referred to collectively herein as a “provider profile” that associates SIM 11 with a specific subscriber of a specific telecommunications services provider.

In order to obtain the provider profile for installation, SIM 11 also includes communication code 54 that is executed by processor 12 and by a host such as a cellular telephone. While SIM 11 is installed in the host, the host executes the relevant portion of communication code 54 along with its own code to follow a data communication protocol such as GPRS to communicate with a server that is associated with the telecommunications services provider and request the provider profile.

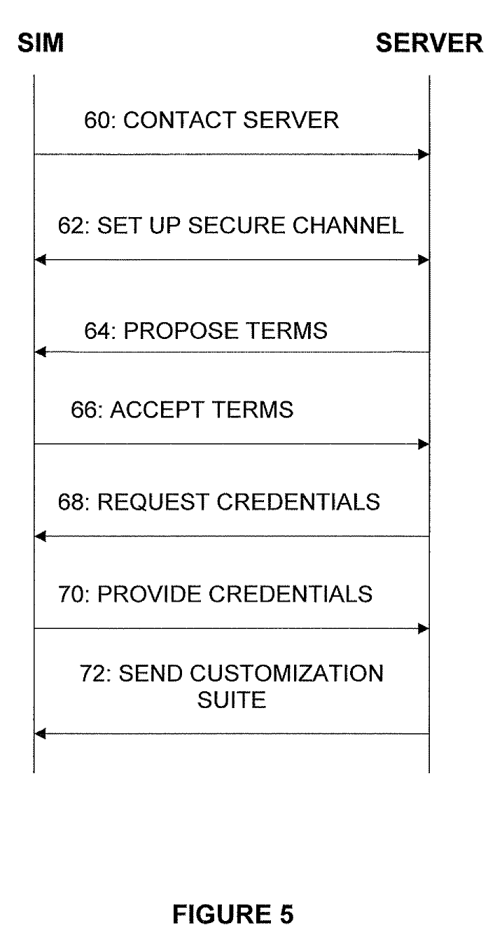

FIG. 5 shows the exchange of signals between SIM 11 and a server for requesting a provider profile. In step 60, the user uses the cellular telephone in which SIM 10 is installed to initiate communication with the server. In step 62, SIM 11 and the server set up a secure channel for uploading user credentials to the server and downloading the provider profile to SIM 11, using methods known in the art that need not be detailed here. For that purpose, communication code 54 includes code 56 for setting up the secure channel. In step 64, the server proposes terms of usage to SIM 11. If the user decides to accept the proposed terms of usage, in step 66 the user uses the cellular telephone in which SIM 11 is installed to send a message to the server indicating acceptance of the terms of usage. In step 68, the server requests user credentials, such as a mailing address and a credit card number, for registering the user as a subscriber to the telecommunications services provider with which the server is associated. In step 70, the user uses the cellular telephone in which SIM 11 is installed to send the requested credentials to the server. In step 72, having authenticated the user credentials, the server sends a “customization suite” to SIM 11. The customization suite includes the provider-specific data (both data generic to the provider and data such as an IMSI and one or more authentication keys that are specific to SIM 11) that SIM 11 needs for executing installation code 50 to install the provider profile. Optionally, the customization suite also includes provider-specific instructions (e.g. in the form of a script) that supplement installation code 50. Processor 12 executes communication code 54 to effect the SIM-11-side portion of the provider profile request.

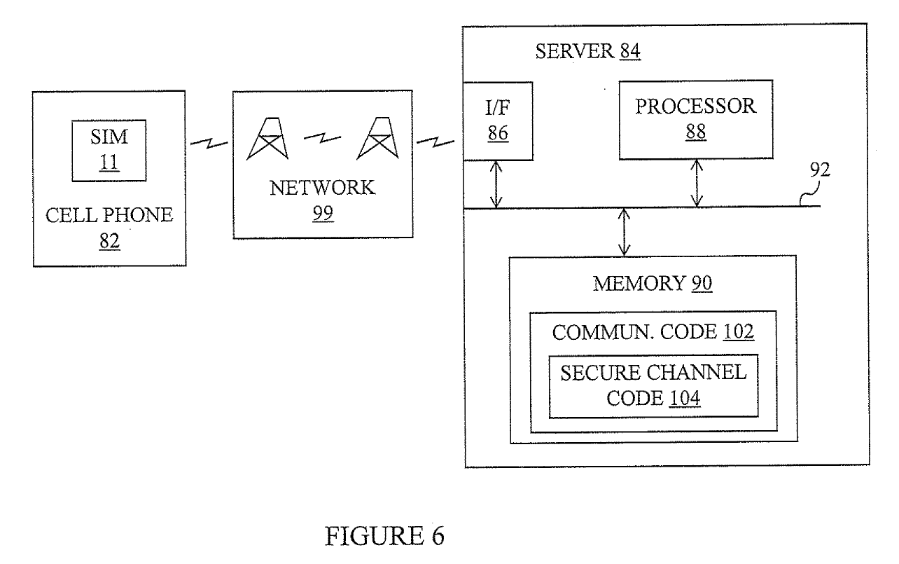

FIG. 6 shows SIM 11, installed in a cellular telephone 82, communicating with a server 84 via a cellular telephony network 94 to effect the steps illustrated in FIG. 5. Server 84 includes, among other components, an interface 86 to network 94, a memory 90 wherein is stored code 102 for implementing the server-side steps of FIG. 5, and a processor 88 for executing code 102. Interface 86, memory 90 and processor 88 communicate with each other via a bus 92. Code 102 includes, inter alia, secure channel code 104 that is similar to secure channel code 56.

FIGS. 4A and 4B also show code 31 of a generic SIM 10 as including deletion code 52 and as including, in installation code 50: a module 58 for adding to SIM 11 a second provider profile of a second telecommunications services provider (in addition to a first provider profile of a first telecommunications services provider that is already installed in SIM 11); a module 59 for deleting a provider profile from SIM 11; and a module 60 for substituting in SIM 11 a second provider profile of a second telecommunications services provider for a first provider profile of a first telecommunications services provider (that is already installed in SIM 11).

In some embodiments of a generic SIM 11, modules 58, 59 and 60 may be absent and deletion code 52 may be executed automatically, upon the successful completion of personalization of SIM 11, to delete installation code 50, communication code 54 and deletion code 52 itself. Subsequent to such deletion, the hierarchical structure of code 31 then is the same as that of code 30 of the prior art, as illustrated in FIG. 2. In other embodiments of a generic SIM 11, the execution of deletion code 52 may be optional.

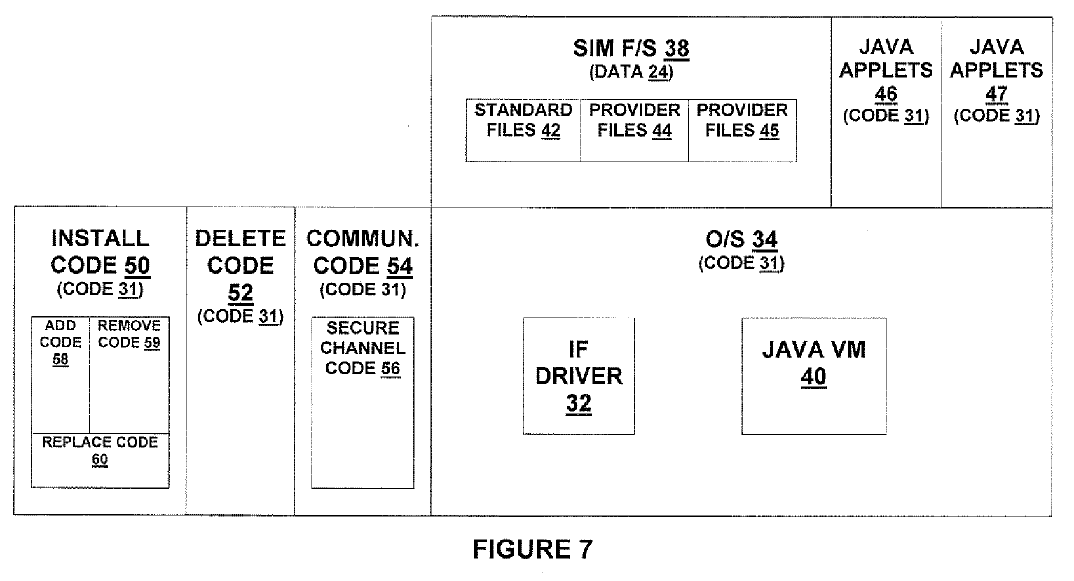

Module 58 gives the user the option of subscribing to two or more different telecommunications services providers at the same time. Executing module 58 effects the steps illustrated in FIG. 5 to add a second provider profile to SIM 11. The hierarchical architecture of code 31 after such an addition is illustrated in FIG. 7. In addition to files 44 and JAVA applets 46 that are specific to the first telecommunications provider, code 31 and data 24 now include files 45 and JAVA applets 47 of the second telecommunications provider. Module 59 gives the user the option of deleting any or all of the installed provider profiles from SIM 11. Module 60 gives the user the option of substituting the provider profile of a second telecommunications provider for the provider profile of a first telecommunications provider. Executing module 60 executes module 59 to delete an installed provider profile and then effects the steps illustrated in FIG. 5 to install the new provider profile.

Server 84 of FIG. 6 may be owned either by the manufacturer of generic SIM cards 11 or by a telecommunications services provider. If server 84 is owned by the manufacturer of generic SIM cards 11 then server 84 provides subscription services for telecommunications services providers that have made the appropriate arrangements with the manufacturer of generic SIM cards 11. In step 60 of FIG. 5, in addition to calling server 84, the user also specifies which telecommunications services provider the user wishes to subscribe to. In step 72 of FIG. 5, in addition to sending the user the provider profile, server 84 also sends the user's credentials to the selected telecommunications services provider, via cellular telephony network 94. If server 84 is owned by a telecommunications services provider, for example if the manufacturer of generic SIM cards 11 has sold server 84 to the telecommunications services provider, then in step 70 of FIG. 5, upon receiving the user's credentials, the telecommunication services provider sets up an account for the user.

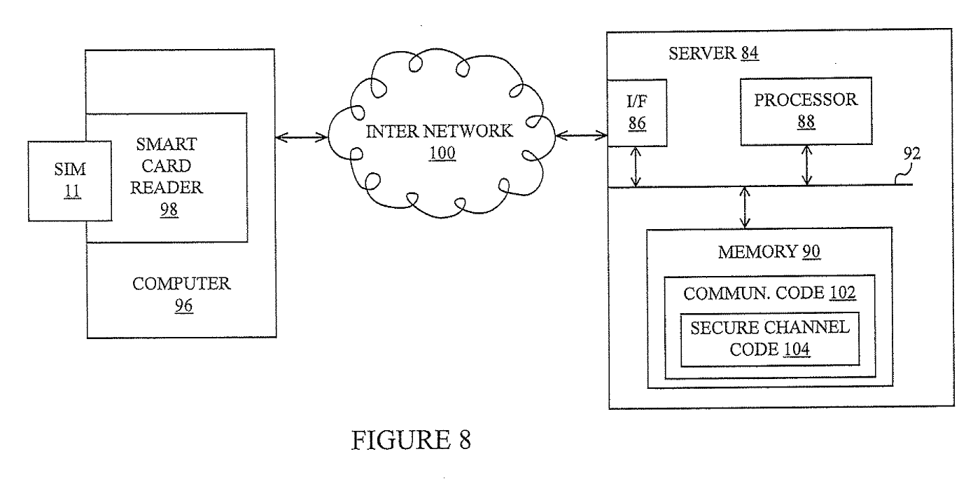

FIG. 8 shows an alternative mechanism for establishing communication between SIM 11 and server 84. In FIG. 8, the host of SIM 11 is a computer 96 equipped with a smart card reader 98 to which SIM 11 is operationally coupled via its interface 14. Computer 96 communicates with server 84 via an internetwork 100 such as the Internet. Computer 96 would be used, for example, by a retail vendor of generic smart cards 11 who offers generic smart cards 11 for sale to users and who personalizes generic smart cards 11 for users who purchase generic smart cards 11. The manufacturer of generic smart cards 11, in turn offers generic smart cards 11 for sale to such retail vendors, instead of or in addition to offering conventional SIMs 10 for sale to telecommunications services providers. Optionally, code 54 for communicating with server 84 resides in computer 96 rather than in generic smart is cards 11; the corresponding hierarchical architecture of code 31 of such a generic smart cards 11 is shown in FIG. 4C.

Yet another mechanism (not illustrated) for establishing communication between SIM 11 and server 84 may be a blend of the two mechanisms illustrated in FIGS. 6 and 8. In this mechanism, cell phone 82 communicates with server 84 via computer 96, using e.g. USB to communicate with computer 96.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of recruiting a new subscriber to a communication services provider, comprising:
(a) receiving a request to provide a customization suite for installing substantially all of a provider profile in an identity module in order to associate the identity module with a communication services provider, thereby enabling the identity module to support communication services provided by the communication services provider, the request being received from a host of the identity module, the identity module lacking any portion of the provider profile;
(b) responding to the request by proposing to the host terms of usage of the communication services; and
(c) upon receiving from the host a consent to the terms of usage, sending the customization suite to the host.

2. The method of claim 1, further comprising:
(d) establishing a secure channel to the host, the sending of the customization suite to the host then being via the secure channel.

3. The method of claim 1, wherein the consent includes a credential, the method further comprising:
(d) validating the credential, the sending of the customization suite to the host being conditional on a validity of the credential.

4. The method of claim 1, wherein the receiving, responding and sending are via a telecommunication network.

5. The method of claim 4, wherein the telecommunication network is a cellular telephony network.

6. The method of claim 4, wherein the telecommunication network is an internetwork.

7. A method of doing business, comprising:
(a) obtaining an identity module for using a host, wherein the identity module is operationally connected, to communicate using communication services provided by a communication services provider when the identity module has installed therein a provider profile that associates the identity module with the communication services provider, the identity module initially lacking any portion of any such provider profile; and
(b) offering the identity module for sale to a potential subscriber of such a communication services provider.

8. The method of claim 7, further comprising.
(c) requesting, on behalf of the potential subscriber, one such provider profile.

9. A method of doing business, comprising:
(a) configuring an identity module initially without any portion of a provider profile that associates the identity module with a communication services provider, the identity module being for using a host, wherein the identity module is operationally connected, to communicate using communication services provided by the communication services provider with which the identity module is associated by the provider profile; and
(b) offering the identity module so configured for sale to a potential subscriber of such a communication services provider.
